(19) United States
(12) Patent Application Publication
(10) Pub. No.: US 2007/0280873 A1
(43) Pub. Date: Dec. 6, 2007

(54) HYDROGENATION OF ENDOHEDRAL METALLOFULLERENES

(76) Inventors: Harry C. Dorn, Blacksburg, VA (US); Harry W. Gibson, Blacksburg, VA (US); Wujun Fu, Blacksburg, VA (US)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/746,808

(22) Filed: May 10, 2007

Related U.S. Application Data
(60) Provisional application No. 60/746,896, filed on May 10, 2006.

(51) Int. Cl. B82B 1/00

(52) U.S. Cl. 423/445 B; 977/736

(57) ABSTRACT

Hydrogenated trimetallic nitride endohedral metallofullerenes and various methods for producing these hydrogenated compounds are described. The hydrogenated trimetallic nitride endohedral metallofullerenes may be partially or fully hydrogenated. In some embodiments, the hydrogenated trimetallic nitride endohedral metallofullerenes exhibits increased water solubility. The hydrogenated trimetallic nitride endohedral metallofullerenes may be a potential source of hydrogen for fuel cell applications, as well as possess a number of potentially useful biological, magnetic, electronic, and chemical properties, with some being useful as MRI contrast agents.

### CROSS-REFERENCE TO RELATED APPLICATIONS

This application claims the benefit of U.S. Provisional Application No. 60/746,896, filed May 10, 2006, herein specifically incorporated by reference in its entirety.

### FIELD OF THE INVENTION

Embodiments of the present invention are directed to families of hydrogenated endohedral metallofullerenes. In certain embodiments, the invention includes families of hydrogenated trimetallic nitride endohedral metallofullerenes and methods for producing hydrogenated trimetallic nitride endohedral metallofullerenes.

### BACKGROUND OF THE INVENTION

Fullerenes are a family of closed-caged molecules made up of carbon atoms. The structure of the fullerenes typically includes multiple numbers of five and six member carbon rings connected together to form a closed-caged molecule. A common fullerene is the spherical C₆₀ molecule taking on the familiar shape of a soccer ball. The fullerene molecules can contain 500 or more carbon atoms.

### SUMMARY OF THE INVENTION

Fullerenes are under investigation as sources of molecular hydrogen for use in fuel cells. However, the carbon atoms of the fullerenes must first be hydrogenated. Zhang, et al. reported hydrogenating C₆₀ to form the partially hydrogenated C₆₀H₃₆. To provide more molecular hydrogen per fullerene, it is desirable to provide fullerenes with increased levels of hydrogenation.

Trimetallic nitride endohedral metallofullerenes possess a number of potentially useful biological, magnetic, electronic, and chemical properties. U.S. Pat. No. 6,303,760, herein specifically incorporated by reference, describes the preparation of a family of trimetallic nitride endohedral metallofullerenes.

In some embodiments, a hydrogenated endohedral metallofullerene may comprise at least one metal encapsulated in a carbon fullerene cage, where the carbon fullerene cage comprises a plurality of carbon atoms, and where at least a portion of the carbon atoms of the fullerene cage are bonded to hydrogen. In further embodiments, the at least one metal may by a metal associated with an encapsulated trimetallic nitride having the formula A₃₋ₙXₙN, wherein A is a metal, X is a second metal, n is an integer from 0 to 3. The carbon fullerene cage may have the formula Cₘ where m is an even integer from 60 to 200. In various embodiments, A and X are trivalent metals. In other embodiments, A and/or X may include, but are not limited to, a group IIIB element, Scandium, Yttrium, Lanthanum, Gadolinium, Holmium, Erbium, Thulium, or Ytterbium. A and X may be the same or different. In certain embodiments the carbon fullerene cage may include, but is not limited to C₆₀, C₆₈, C₈₀, and C₈₄ fullerene cages.

In various embodiments the hydrogenated endohedral metallofullerene may have greater than 20% of the carbon atoms of the fullerene cage that are bonded to hydrogen. In other embodiments, the hydrogenated endohedral metallofullerene may have greater than 50% to 70% of the carbon atoms of the fullerene cage that are bonded to hydrogen. In still additional embodiments, the hydrogenated endohedral metallofullerene may have as much as 95% to all of the carbon atoms of the fullerene cage bonded to hydrogen.

Embodiments of the invention may also include methods for hydrogenating endohedral metallofullerenes. In accordance with an embodiment, the method may comprise providing an endohedral metallofullerene, a solvated electron, and a hydrogen donor in a reaction vessel, and allowing the endohedral metallofullerene, solvated electron, and hydrogen donor to react for a period of time sufficient to form a hydrogenated endohedral metallofullerene, wherein the hydrogenated endohedral metallofullerene comprises a trimetallic nitride encapsulated in a carbon fullerene cage, wherein the carbon fullerene cage comprises a plurality of carbon atoms, and wherein at least a portion of the carbon atoms of the fullerene cage are bonded to hydrogen. In some embodiments, the solvated electron may be generated by providing a group I metal and an amine. In various embodiments, the hydrogen donor may be an alcohol, however, other hydrogen donors may be used.

### BRIEF DESCRIPTION OF SEVERAL VIEWS OF THE DRAWING(S)

FIG. 1 illustrates HPLC traces for the starting material Sc₃N@C₈₀ and after the reaction was allowed to proceed to form hydrogenated Sc₃N@C₈₀.

FIG. 2 illustrates the mass spectrum (MALDI-MS) illustrating the formation of the fully hydrogenated Sc₃N@C₈₀H₈₀. as well as the presence of Sc₃N@C₈₀H₈₀O.

FIG. 3 illustrates the mass spectrum for a hydrogenated Sc₃N@C₈₀H₇₄ with an associated ethylenediamine.

FIG. 4 illustrates the H¹ NMR spectrum for hydrogenated Sc₃N@C₈₀.

FIG. 5 illustrates the HPLC traces for the starting material Gd₃N@C₈₀ and after the reaction was allowed to proceed to form hydrogenated Gd₃N@C₈₀.

FIG. 6 illustrates the HPLC traces for the starting material Tb₃N@C₈₀ and after the reaction was allowed to proceed to form hydrogenated Tb₃N@C₈₀.

### DETAILED DESCRIPTION OF THE INVENTION

Embodiments of the present invention include a family of hydrogenated endohedral metallofullerenes. Endohedral metallofullerenes are fullerene molecules in which one or metal atoms are positioned inside, or otherwise encapsulated in, the fullerene cage. Certain embodiments of the present invention are directed to hydrogenated trimetallic nitride endohedral metallofullerenes. In addition to being a potential source of hydrogen for fuel cell applications, hydrogenated endohedral metallofullerenes and hydrogenated trimetallic nitride endohedral metallofullerenes possess a number of potentially useful biological, magnetic, electronic, and chemical properties, with some being useful as magnetic resonance imaging (MRI) contrast agents. A family of trimetallic nitride endohedral metallofullerenes are described in U.S. Pat. No. 6,303,760, herein specifically incorporated by reference in its entirety. Trimetallic nitride endohedral metallofullerenes may have the general formula A₃₋ₙXnN @Cₘ. where A and X are metal atoms encapsulated in the Cₘ fullerene cage. The size of the fullerene is denoted at the right of the @ symbol. All elements listed to the left of the @ symbol are encapsulated inside the fullerene cage. Further, elements listed to the right of the @ symbol and to the right of the size of the fullerene cage are elements associated with the fullerene cage. Under this notation, Sc₃N@C₈₀H₃₆ represents a Sc₃N trimetallic nitride encapsulated within a C₈₀ fullerene cage with 36 hydrogen atoms associated with the outside or exterior of the fullerene cage. Accepted symbols for elements and subscripts to denote numbers of elements are used herein.

In some embodiments, the trimetallic nitride endohedral metallofullerene may have the formula A₃₋ₙ XₙN@Cₘ with n ranging from 0 to 3, A and X are metal atoms, and m can take on even values between 60 and 200. To form a trimetallic endohedral metallofullerene having a cage size between about 68 carbon atoms and about 80 carbon atoms, the metal atoms are preferably trivalent and have an ionic radius below about 0.095 nm. When m is about 68, the metal atoms preferably have an ionic radius below about 0.090 nm for the A₃N endohedral species. For the AX₂N and A₂XN endohedral species, a larger atomic radius of 0.095 nm for A and X can be accommodated. As the size of the cage increases, the ionic radius for the metal may increase. Further, in various embodiments A and/or X may include, but is not limited to, a trivalent metal, a rare earth element, or a group IIIB element. In other embodiments, A and/or X may be Scandium, Yttrium, Lanthanum, Gadolinium, Holmium, Erbium, Thulium, Ytterbium, as well as various combination thereof. In other embodiments, the trimetallic nitride endohedral metallofullerene may have three different metal atoms associated as a nitride encapsulated within the Cₘ fullerene cage. The Cₘ fullerene cage may take on even values between 60 and 200. In some embodiments the Cₘ fullerene cage may include, but is not limited to, C₆₀, C₆₈, C₇₀, C₈₀, C₈₄, C₈₆, and C₈₈. In some embodiments, the Cₘ fullerene cage may have the general formula C₂ₙ(n=30-60).

Generally, the trimetallic nitride endohedral metallofullerenes are prepared by arc-vaporization of graphite rods packed with one or more metal oxides in a Krätschmer-Huffman generator in the presence of a nitrogen-containing atmosphere. During the arc-vaporization process, a variety of carbon nanomaterials including the trimetallic nitride endohedral metallofullerenes are formed in a reaction soot.

In accordance with embodiments of the invention, a trimetallic nitride endohedral metallofullerene may be hydrogenated such that hydrogen is associated with the Cₘ fullerene cage. The trimetallic nitride endohedral metallofullerene may have varying degrees of hydrogenation. For example, the trimetallic nitride endohedral metallofullerenes may be hydrogenated such that greater than 20% of the carbon atoms of the Cₘ fullerene cage are bonded to hydrogen. In other embodiments, the trimetallic nitride endohedral metallofullerenes may be hydrogenated such that greater than 50% of the carbon atoms of the Cₘ fullerene cage are bonded to hydrogen. In still other embodiments, the trimetallic nitride endohedral metallofullerenes may be hydrogenated such that all or nearly all of the carbon atoms of the Cₘ fullerene cage are bonded to hydrogen.

In general, many trimetallic nitride endohedral metallofullerenes are deeply colored. In some embodiments, the hydrogenated trimetallic nitride endohedral metallofullerene will be substantially colorless. For example Sc₃NC₈₀ exhibits a dark brown color, while the hydrogenated Sc₃NC₈₀H₃₆ or Sc₃NC₈₀H₇₂ is substantially colorless. Further, in various embodiments, the hydrogenate trimetallic nitride endohedral metallofullerene may exhibit increased water solubility, with some hydrogenated endohedral metallofullerenes being substantially water soluble. With some embodiments, there may be two parts of the reaction products, one is toluene soluble and the other is water soluble. Without intending to be bound by theory, the water soluble part is the hydrogenated trimetallic nitride endohedral metallofullerenes with what is believed to be covalent functionalization of an amine group or hydroxyl groups from the solvent. While the exact structures of the hydrogenated trimetallic nitride endohedral metallofullerenes is not yet known, hydrogenation is believed to be occurring with the carbon atoms of the Cₘ fullerene cage as verified by NMR and IR spectroscopy showing peaks consistent with carbon-hydrogen bonds. Without intending to be bound by theory, it is speculated that the hydrogen atoms are positioned on the exterior of the Cₘ fullerene cage. However, it may be possible that some hydrogenation maybe occurring in the interior of the Cₘ fullerene cage. Without intending to be bound by theory, the larger cage fullerenes may allow for hydrogen bonding on the interior of the fullerene cage and potentially reduce ring strain on the fullerene cage.

In accordance with an embodiment of the invention, a hydrogenated trimetallic nitride endohedral metallofullerenes may be prepared by reacting the desired trimetallic nitride endohedral metallofullerene with a hydrogen donor in the presence of a solvated electron or generated radical. The solvated electron may be created by providing ammonia or an amine in the presence of a electron donor, such as a group I metal like lithium, sodium, or potassium. The group I metal is not specifically required to obtain at least partial hydrogenation, but may be used to facilitate hydrogenation. Other species which generate a radical under the hydrogenation reaction conditions may be used for hydrogenating the endohedral metallofullerenes. The amine is not particularly limited and may include primary and secondary amines. If not too sterically hindered, tertiary amines may be utilized as well. In some embodiments, the amine may be a functional moiety on a resin. In other embodiments, the amine may be a diamine, such as ethylene diamine. The hydrogen donor may be water or an alcohol, such as methanol, ethanol, propanol, iso-propanol, butanol, iso-butanol, tertiary-butanol, and other alcohols. The reaction may be sensitive to oxygen, water, and/or light. Accordingly, if desired, standard techniques may be utilized in removing oxygen and water from the solvents and reaction atmosphere to create a substantially oxygen free and water free solvent. Substantially oxygen free and substantially water free means that the solvent, gas, or other material, to which the term pertains has sufficiently reduced levels of either oxygen or water such that the presence of the remaining oxygen or water in the solvent, gas, or other material, will not prevent at least partial hydrogenation of at least a portion of the trimetallic nitride endohedral metallofullerene. In some embodiments, the solvent may be deoxygenated with an inert gas such as argon. Further, in some embodiments, the reaction may be sensitive to ambient light. Accordingly, the reaction may be performed in the absence of light. Standard chemistry techniques may be used to reduce or minimize the presence of oxygen, air, water, and/or light to the reaction mixture. The introduction of oxygen, air, water, or light to the reaction mixture may inhibit or reduce extent of hydrogenation of the trimetallic nitride endohedral metallofullerene. While the hydrogenation reaction may be sensitive to oxygen, water, and/or light, the resulting hydrogenated endohedral metallofullerene species may be relatively stable with respect to oxygen, water, and/or light.

In accordance with some embodiments, to form the hydrogenated trimetallic nitride endohedral metallofullerene, a reactor may be charged with the desired trimetallic nitride endohedral metallofullerene, amine, electron donor or radical generating species, and hydrogen donor in a substantially oxygen free and water free environment. If necessary a solvent may be utilized. In many instances, the amine or liquid ammonia may be used as a solvent system. The reaction may proceed at ambient temperatures and pressures. To increase the rate of reaction, the temperature of the reaction solution may be increased, or conversely to slow the rate of reaction, the temperature of the reaction solution may be decreased. As discussed above, any solvents or gas used during the reaction are preferably substantially oxygen free and substantially water free.

The reaction may be allowed to run for a sufficient time to hydrogenate at least a portion of the carbon atoms of the Cₘ fullerene cage. The reaction may be monitored using standard techniques such as liquid chromatography, high pressure liquid chromatography, H¹ NMR spectroscopy, infrared spectroscopy, UV-VIS spectroscopy, and other similar techniques known to those skilled in the art. In many embodiments, hydrogenation of a trimetallic nitride endohedral metallofullerene will have occurred within a few hours. With some embodiments, a time sufficient to hydrogenate at least a portion of the carbon atoms of the Cₘ fullerene cage may range from about 5 to about 100 hrs. The reaction time may vary depending upon the trimetallic nitride endohedral metallofullerene utilized. The type of encapsulated trimetallic nitride will affect the reaction time. For example, the hydrogenation of Gd₃N@C₈₀ occurred faster than the hydrogenation of Sc₃N@C₈₀ under similar reaction conditions. Additional factors that affect the reaction time included, but are not limited to, size of the Cₘ fullerene cage. the type of electron donating metal, the specific type of amine, the type of hydrogen donating alcohol, the reaction temperature, and the reaction pressure.

The degree of hydrogenation of the Cₘ fullerene cage of the trimetallic nitride endohedral metallofullerene may range from about 20% of the carbon atoms of the fullerene cage to about full hydrogenation. Full hydrogenation is hydrogenation of at least 90% of the carbon atoms of the Cₘ fullerene cage. In other embodiments, the Cₘ fullerene cage of the trimetallic nitride endohedral metallofullerene may be completely hydrogenated such that the number of hydrogen atoms bonded to the Cₘ fullerene cage is the same as the number of carbon atoms making up the Cₘ fullerene cage. In still other embodiments, the degree of hydrogenation of the Cₘ fullerene cage of the trimetallic nitride endohedral metallofullerene may range from about 20% of the carbon atoms making up the fullerene cage to about 75% of the carbon atoms making up the Cₘ fullerene cage.

The amount of hydrogenation of the trimetallic nitride endohedral metallofullerene may be controlled to varying degrees by adjusting various reaction parameters. For example, the stoichiometric ratios of the electron donating metal to trimetallic nitride endohedral metallofullerene may be adjusted to provide the desired degree of hydrogenation. For full hydrogenation, a stoichiometric excess of the electron donating metal and hydrogen donating alcohol to the number of carbon atoms on the Cₘ fullerene cage should be used. In some embodiments, ratios of about 30:1 to about 300:1 electron donating metal to the number of carbon atoms on the Cₘ fullerene cage and greater may be used. In some embodiments, ratios of about 1,000:1 or even 2,000:1 or greater may be used. Routine experimentation may be used to determine the stoichiometric ratio of electron donating metal to trimetallic nitride endohedral metallofullerene for a given level of hydrogenation.

Reducing the relative mole ratio of electron donating metal to the number of carbon atoms on the fullerene cage may reduce the amount of hydrogenation of the Cₘ fullerene cage. For partial hydrogenation of the trimetallic nitride endohedral metallofullerene, in some embodiments, the mole ratio of electron donating metal to the number of carbon atoms of the Cₘ fullerene cage may be less than about 1:1. The lower limit of the mole ratio of electron donating metal to number of carbon atoms on the Cₘ fullerene cage is not particularly limited and may be adjusted to correspond to the level of desired hydrogenation of the trimetallic nitride endohedral metallofullerene. In some embodiments for partial hydrogenation, the mole ratio of electron donating metal to the number of carbon atoms of the Cₘ fullerene cage may range from about 1:90 up to less than about 1:1. As the mole ratio of electron donating metal to the number of carbon atoms of the Cₘ fullerene cage gets lower, there may be some trimetallic nitride endohedral metallofullerene starting material that remains unreacted with only a portion becoming hydrogenated.

Since the reaction may be sensitive to water and/or oxygen, in some embodiments, the level of water and/or oxygen may be adjusted to inhibit the hydrogenation reaction such that a lower degree of hydrogenation of the trimetallic nitride endohedral metallofullerene occurs. In some embodiments, through routine experimentation, the water and/or oxygen levels may be adjusted to provide a partially hydrogenated trimetallic nitride endohedral metallofullerene. With certain embodiments, increasing the levels of water and/or oxygen will inhibit the hydrogenation reaction such that lower degrees of hydrogenation of trimetallic nitride endohedral metallofullerenes may occur. Further, in some embodiments, the addition of an alcohol may lower the degree of hydrogenation.

Another way to control the amount of hydrogenation may include slowing the rate of reaction by cooling the temperature of the reactants and monitoring the extent of reaction by one or more of the techniques discussed above. When the desired amount of hydrogenation has occurred the reaction mixture may be quenched by using water or potentially oxygen.

In some embodiments, the hydrogenated trimetallic nitride endohedral metallofullerene may form an adduct with the amine used in the hydrogenation reaction. In various embodiments in which less than 100% hydrogenation has occurred, the trimetallic nitride endohedral metallofullerene will form an adduct with one or more amines present in the reaction mixture. The amine derivatized hydrogenated trimetallic nitride endohedral metallofullerene may be useful for preparing additional derivatized endohedral metallofullerenes. Without intending to be bound by theory, it is believed that the hydrogenated trimetallic nitride endohedral metallofullerene and associated amine are covalently bonded to one another.

The following examples are provided to illustrate various embodiments of the invention.

Hydrogenation of Sc₃N@C₈₀

Sc₃N@C₈₀ (3.0 mg, 0.0027 mmol) was dissolved in 6 ml ethylediamine (0.5 mg/ml concentration) and 201.5 mg (2.7 mmol) of tert-Butanol was added. The resulting solution was deoxygenated with argon about half an hour to remove oxygen. To this solution, 19.5. mg (2.8 mmol) of lithium metal was added.

The mixture was stirred vigorously under a N₂ atmosphere. The dark brown solution turned to yellow and then blue. However the blue color disappeared quickly owing to the decay of the solvated electrons. After the 24 hours, the solution turned to light yellow. The solution turned back to blue after adding additional 19.5 mg (2.8 mmol) of lithium metal. Keep stirring the mixture under a N₂ atmosphere for additional 24 hours.

After reaction is complete, the resulting solution was then poured into 10 ml of ice water to destroy the excess lithium metal. The mixture was extracted with toluene, and the organic layer was further washed with brine and dried over Na₂SO₄. The solvent was evaporated under reduced pressure to get hydrogenated Sc₃N@C₈₀.

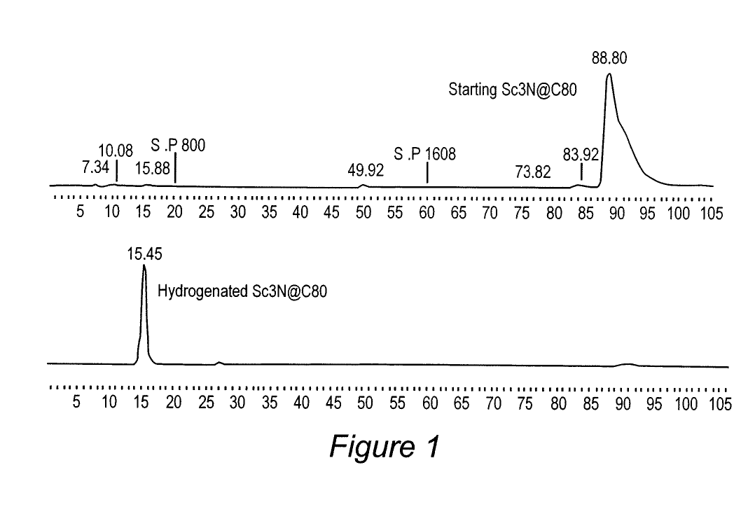

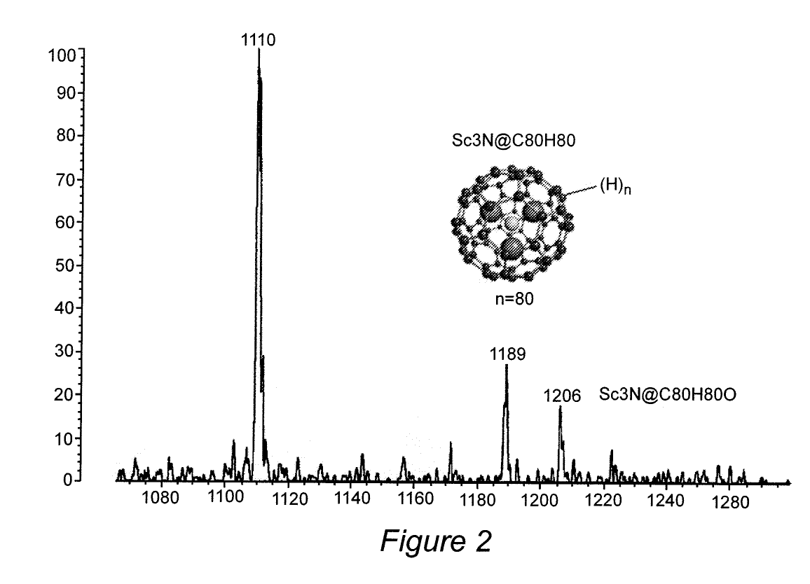

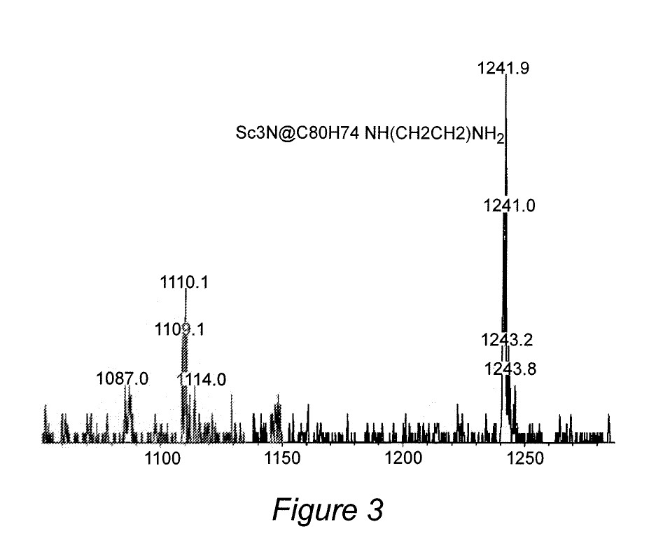

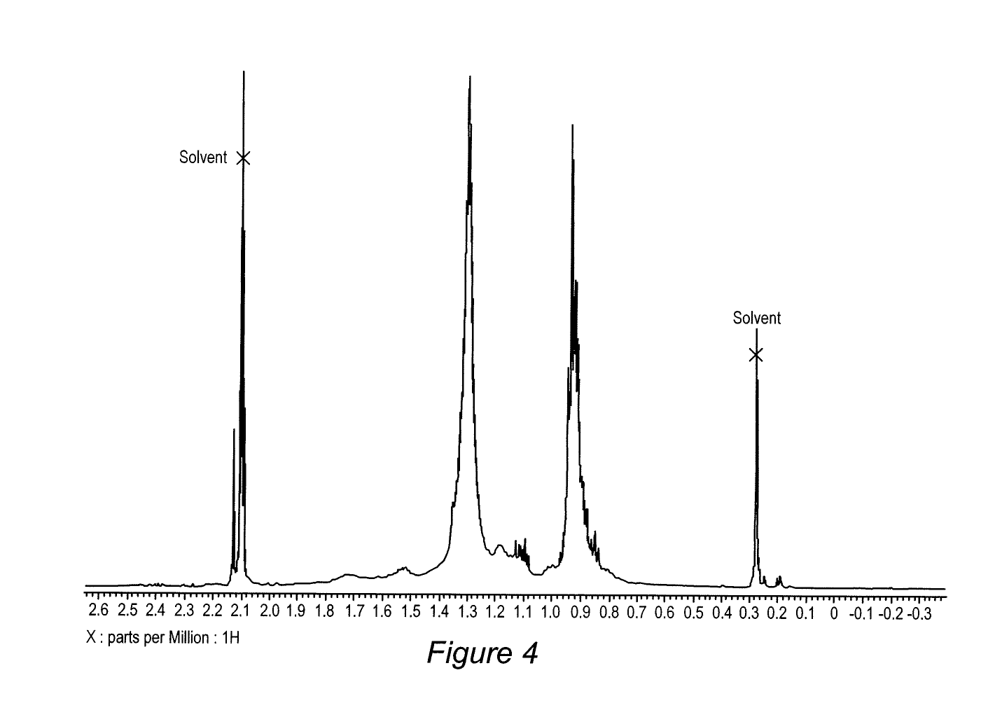

FIG. 1 shows the HPLC traces for the starting material Sc₃N@C₈₀ and after the reaction was allowed to proceed to form hydrogenated Sc₃N@C₈₀. As seen in FIG. 2, the mass spectrum (MALDI-MS) indicated the formation of the fully hydrogenated Sc₃N@C₈₀H₈₀. as well as the presence of Sc₃N@C₈₀H₈₀O. As shown in FIG. 3, the mass spectrum also revealed a hydrogenated Sc₃N@C₈₀H₇₄ with an associated ethylenediamine. The H¹ NMR spectrum confirmed the presence of carbon hydrogen bonds as shown in FIG. 4.

Hydrogenation of Gd₃N@C₈₀

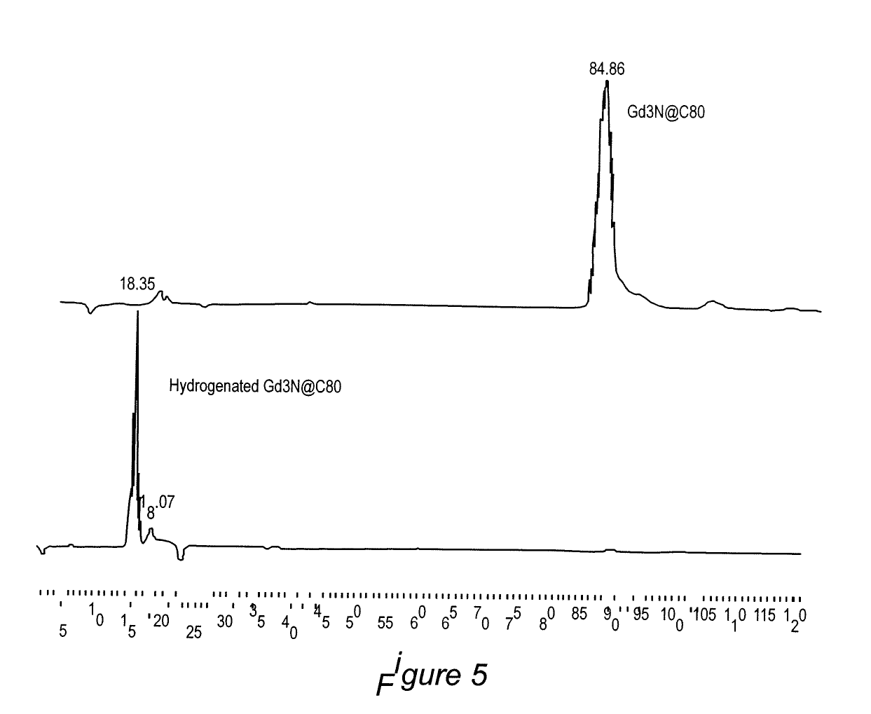

The same procedure was followed above for the hydrogenation of Sc₃N@C₈₀ except that Sc₃N@C₈₀ was replaced with Gd₃N@C₈₀. The reaction was allowed to proceed as describe in the previous example to form the hydrogenated Gd₃N@C₈₀. FIG. 5 illustrates the HPLC traces for the starting material and the hydrogenated reaction products.

Hydrogenation of Tb₃N@C₈₀

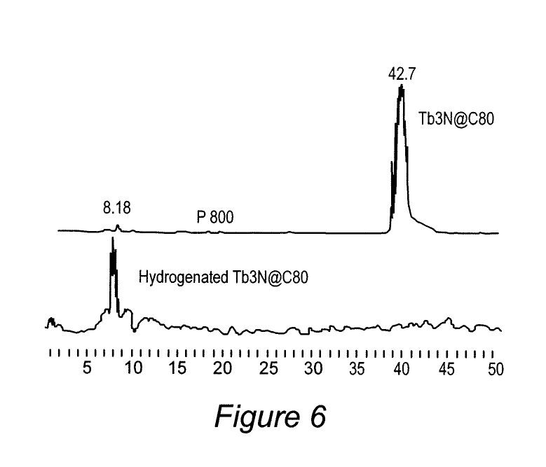

The same procedure was followed above for the hydrogenation of Sc₃N@C₈₀ except that Sc₃N@C₈₀ was replaced with Tb₃N@C₈₀. The reaction was allowed to proceed as describe in the previous example to form the hydrogenated Tb₃N@C₈₀. FIG. 6 illustrates the HPLC traces for the starting material and the hydrogenated reaction products.

While various embodiments of the invention have been described in detail, the invention is limited only by the appended claims.

What is claimed is:

1. A hydrogenated endohedral metallofullerene comprising:
at least one metal encapsulated in a carbon fullerene cage, wherein the carbon fullerene cage comprises a plurality of carbon atoms, and wherein at least a portion of the carbon atoms of the fullerene cage are bonded to hydrogen.

2. The hydrogenated endohedral metallofullerene of claim 1, wherein the at least one metal is a metal associated with an encapsulated trimetallic nitride having the formula A₃₋ₙXₙN, wherein A is a metal, X is a second metal, n is an integer from 0 to 3, and wherein the carbon fullerene cage has the formula Cₘ, wherein m is an even integer from 60 to 200.

3. The hydrogenated endohedral metallofullerene of claim 2, wherein:
A is selected from the group consisting of Scandium, Yttrium, Lanthanum, Gadolinium, Holmium, Erbium, Thulium, and Ytterbium; and
X is selected from the group consisting of Scandium, Yttrium, Lanthanum, Gadolinium, Holmium, Erbium, Thulium, and Ytterbium.

4. The hydrogenated endohedral metallofullerene of claim 3, wherein X and A are different.

5. The hydrogenated endohedral metallofullerene of claim 2, wherein A is selected from the group consisting of a rare earth element and a group IIIB element.

6. The hydrogenated endohedral metallofullerene of claim 2, wherein X is selected from the group consisting of a rare earth element and a group IIIB element.

7. The hydrogenated endohedral metallofullerene of claim 1, wherein the carbon fullerene cage is selected from the group consisting of C₆₀, C₆₈, C₇₀, C₈₀, C₈₄, C₈₆, and C₈₈ fullerene cages.

8. The hydrogenated endohedral metallofullerene of claim 1, wherein greater than 20% of the carbon atoms of the fullerene cage are bonded to hydrogen.

9. The hydrogenated endohedral metallofullerene of claim 1, wherein the degree of hydrogenation ranges from about 20% to about 75%.

10. The hydrogenated endohedral metallofullerene of claim 1, wherein all of the carbon atoms of the fullerene cage are bonded to hydrogen.

11. The hydrogenated endohedral metallofullerene of claim 1, wherein the hydrogenated endohedral metallofullerene is soluble in water.

12. The hydrogenated endohedral metallofullerene of claim 2, wherein A is Scandium, x is 0, m is 80.

13. The hydrogenated endohedral metallofullerene of claim 2, wherein A is Gadolinium, x is 0, m is 80.

14. The hydrogenated endohedral metallofullerene of claim 2, wherein the hydrogenated endohedral metallofullerene is colorless.

15. A method for hydrogenating endohedral metallofullerenes, the method comprising the steps of:
providing an endohedral metallofullerene, a solvated electron, and a hydrogen donor in a reaction vessel; and
allowing the endohedral metallofullerene, solvated electron, and hydrogen donor to react for a period of time sufficient to form a hydrogenated endohedral metallofullerene, wherein the hydrogenated endohedral metallofullerene comprises a trimetallic nitride encapsulated in a carbon fullerene cage, wherein the carbon fullerene cage comprises a plurality of carbon atoms, and wherein at least a portion of the carbon atoms of the fullerene cage are bonded to hydrogen.

16. The method of claim 15, wherein the solvated electron is generated by providing a group I metal and an amine.

17. The method of claim 15, wherein the hydrogen donor is an alcohol.

18. The method of claim 15, wherein the solvated electron is generated by providing a group I metal and an amine, and wherein the hydrogen donor is an alcohol.

19. The method of claim 15, wherein the solvated electron is generated by providing lithium with ethylene diamine, and wherein the hydrogen donor is tertiary butanol.

20. The method of claim 15, wherein a solvated electron is provided in an amount sufficient to hydrogenate more than 50% of the carbon atoms of the fullerene cage.
